(19) United States
(12) Patent Application Publication
(10) Pub. No.: US 2005/0160469 A1
(43) Pub. Date: Jul. 21, 2005

(54) Interactive video data generating system and method thereof

(76) Inventors: Chaucer Chiu, Taipei (TW); Hsien-Chun Chang, Shanhai City (CN)

Correspondence Address: RABIN & BERDO, P.C., Suite 500, 1101 14 Street, N.W., Washington, DC, 20005, US

(21) Appl. No.: 10/759,296

(22) Filed: Jan. 20, 2004

(51) Int. Cl. H04N 7/173; G06F 17/21; G06F 17/00; G06F 15/00

(52) U.S. Cl. 725/112; 725/113; 715/500.1; 715/501.1

(57) ABSTRACT

An interactive video generating system and method allow a user to establish link relations in the video content, so that an instantaneous broadcast according to desired selections of the user can be performed. Interactive link relations between the video files are achieved by means of block locations. With this system and method, more flexibility and selectivity are allowed to the user who no longer is limited to a unidirectional fixed video broadcast sequence.

### BACKGROUND OF THE INVENTION

1. Field of Invention

The present invention relates to a video generating system and method, more particularly a system and method that can establish link relations between different video contents by means of block locations, to obtain interactive video broadcasting.

2. Related Art

Present video media include diverse types such as television, cinema, optical video discs, etc. Regardless of whether these video media use video information recorded beforehand or recorded in real-time, their broadcasting usually is time-sequential. In other words, the user can receive the broadcast video file only according to a unidirectional and fixed sequence. In addition, the user usually is allowed to perform only simple manipulations on the broadcast video sequence, such as fast forward move, reverse move, broadcast, pause, stop, etc. Presently, the user cannot effectuate any adjustment according to actual content broadcast demands. The present state of the art therefore encounters diverse issues such as single video broadcast contents, unidirectional broadcast sequence, and low interactivity with the user.

One cause of the foregoing problems resides in the time-sequence nature of traditional video broadcasting. To improve these issues, an interesting approach is to base the generation of video data on its content, and establish link relations between video files. With video files formed with link relations, different types of video switching/broadcasting functionality can be performed according to real-time manipulations of the user, who can watch different video files. With this method, the video files can be implemented in a wide range of application such as video games, advertisement, multimedia, etc. Important improvements therefore are needed in the video industry, which researches and developments will likely focus on a video generating system and method that can provide more interactivity and flexibility in application.

### SUMMARY OF THE INVENTION

It is therefore an objective of the invention to provide an interactive video generating system and method that can provide high interactivity with the content of the broadcast video file, and thereby overcome the prior problems of unidirectional fixed broadcast sequence.

According to an embodiment, the interactive video generating system comprises a file document database 110, a link display module 120, a selection input module 130, a block defining module 140, and a relation generating module 150.

According to another embodiment, an interactive video generating method comprises: (1) analyzing position data of a display page frame of a video data selection; (2) performing a block locating process in the display page frame; (3) creating a link record of the display page frame and saving it; (4) performing a tracking and defining process in a next page frame; and (5) generating a relation data document corresponding to the video data selection.

In the system and method of the invention, interactive link relations can be created between video files via block locations in the page fames of the video files. Via a user selection and/or input manipulation, the block locating process is automatically performed to create corresponding link records and corresponding relation data documents. The video content therefore can be subjected to reference via the link records in the relation data documents so that an interactive video broadcast with instantaneous broadcast according to desired selections can be obtained.

By forming interactive video files, the user is more inclined to actively participate in the video broadcasting process, which makes it more attractive and flexible for a wide range of applications.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and is thus not limitative of the present invention, and wherein:

FIG. 1 is a schematic diagram of an interactive video data generating system and method according to an embodiment of the invention;

FIG. 2a is a flowchart of an interactive video data generating method according to an embodiment of the invention;

FIG. 2b is flowchart of a block locating process of a display page frame implemented in an interactive video data generating method according to an embodiment of the invention;

FIG. 2c is a flowchart of a tracking and defining process of a video data selection implemented in an interactive video data generating method according to an embodiment of the invention;

FIG. 3 is a flowchart of a tracking and defining process implemented to create relation data documents in an interactive video data generating method according to an embodiment of the invention; and

FIG. 4 is a schematic view of an interactive video-broadcasting interface implemented in an interactive video data generating system and method according to an embodiment of the invention.

### DETAILED DESCRIPTION OF THE INVENTION

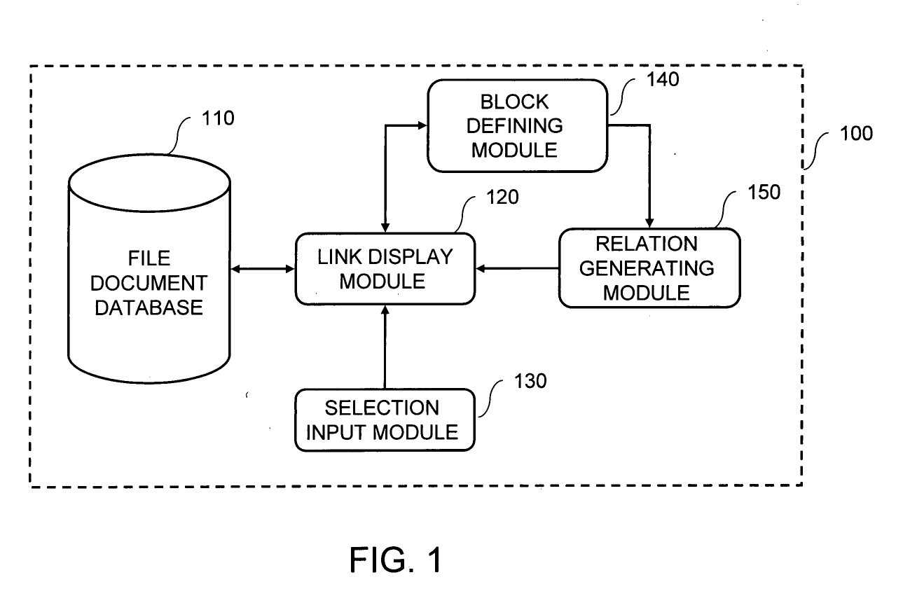

The invention provides an interactive video data generating system and method. Referring to FIG. 1, an interactive video data generating system comprises the following elements.

A file document database 110 stores video files for link relation and relation data documents 820 corresponding to the video files.

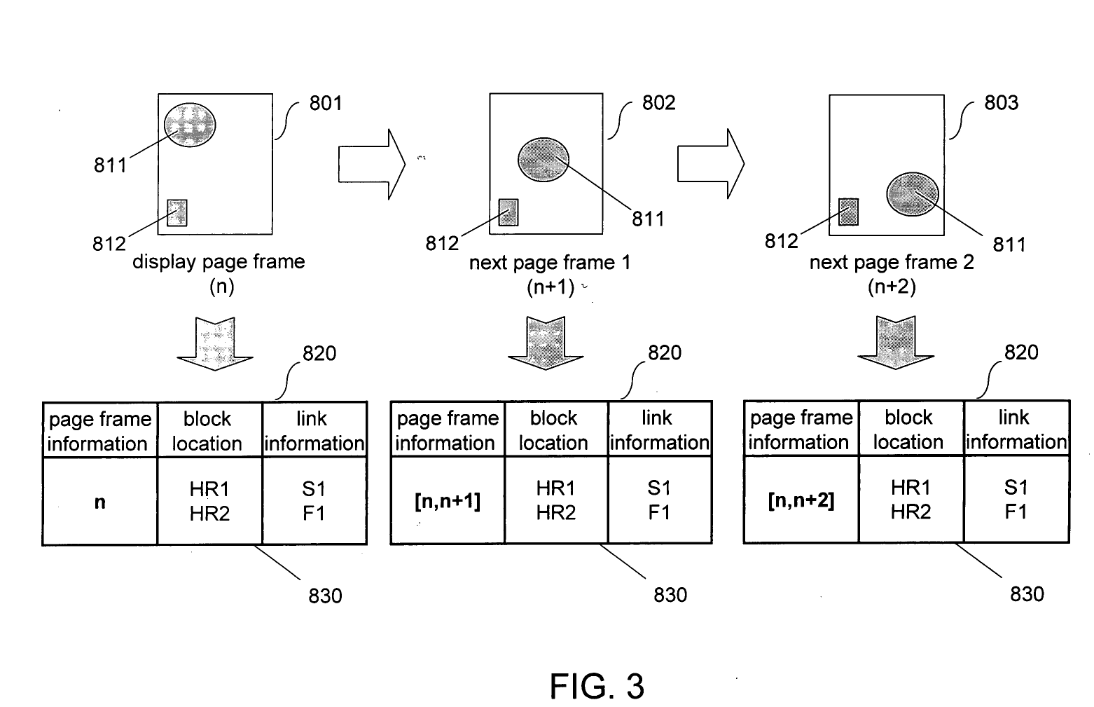

The video files can be generated with diverse encoding formats. Link relations can be established for different encoding types or formats of video files. The relation data documents 820 include a plurality of link records 830. When a video file is being broadcasted, the link records are used for reference according to the user's selection, and then are used for selectively broadcasting other corresponding video files or sections. Generally, the link records 830 of the relation data documents 820 at least include the following elements (FIG. 3 illustrates an example of relation data documents 820):
(a) page frame data, recording the page frame having a link relation, wherein the page frame data can support a single page frame number (for example, “n” will indicate the n-th page frame), or a page frame number range (for example, [n, n+2] refers to all the page frames between the page frame number n and the page frame number (n+2);
(b) block data, recording the block location set as a link relation. Its name can be desirably defined by the user; generally, each page frame can have more than one block location settings at the same time; and
(c) link data, respectively corresponding to the block data and used for recording video files or sections referred to by the link relations of the block locations.

A link display module 120 provides a user interface operable to display tables of video files. In addition, the link display module 120 receives event-triggering signals to prompt selected video items and broadcast display page frames with the corresponding relation data documents 820.

The user interface provides diverse manipulating options such as selecting the video file(s), to be subjected to a link relation. The user interface can display in hierarchical menu the video files of the file document database 110 or the link records 830 of the relation data documents 820 for user's selection and manipulation. The whole user interface performs displaying according to a “What You See Is What You Get” (WYSIWYG) mode, so that the user can control any change and modification made in video file tables or link records 830 of the relation data document 820. When the user wants to set a video link relation, a selection of video data is to be decided first. The user interface then provides the user with the display page frame of the video data selected by the user as reference for a link relation.

A selection input module 130 generates an event-triggering signal according to the user's selection/input manipulation, by means of which selection and input of video data and a display page frame can be entered in the system.

The event-triggering signal is created by a user's manipulation. Usually, this event-triggering signal is created via triggering a sensitive display device, such as a touch panel display screen or a pointing positioning device, such as a computer mouse.

A block defining module 140 proceeds to block locating according to the user's selection/input of the display page frames of the video data selection, and generates link records 830, stored in the relation data document 820 corresponding to the video data selection.

The block locating process performed by the block-defining module 140 comprises the following parts:
(a) an optical flow analysis, where an initial block boundary corresponding to the user's selection is evaluated according to similar optical properties;
(b) a feature extraction, where contents of the initial block boundary without similar features are filtered out; and
(c) a clustering treatment, where adaptive bounding techniques are applied to the remaining pixels with similar features to mark up and generate an exact block location.

According to the block location data generated by the block defining module 140, a relation generating module 150 then tracks and defines similar block locations in the following page frames of the video data selection. The definition results then are added to the relation data document 820 corresponding to the video data selection.

Generally, it may happen that a same block location of a video data selection appears in different page frames. To avoid repeating the same block locating manipulation, the relation generating module 150 according to variations such as ‘in direction of movement’, locations, etc., implements spatio-temporal matching techniques to infer the positions in other page frames where the same block location may appear. The relation- generating module 150 then defines the block location found in the following page frame according to the link record 830 of the block location of the previous page frame. All the same block locations in the entire video data selection thereby are set with the same link relation.

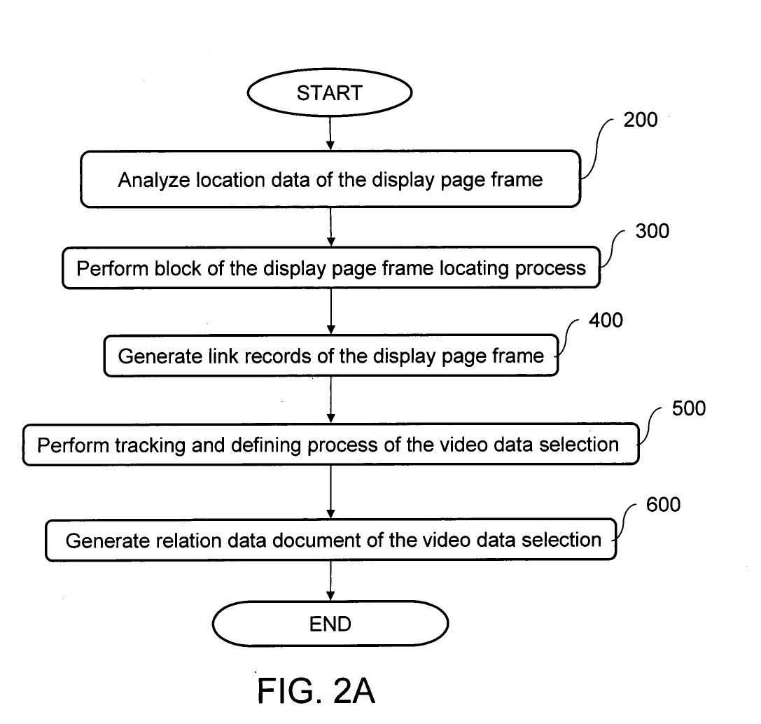

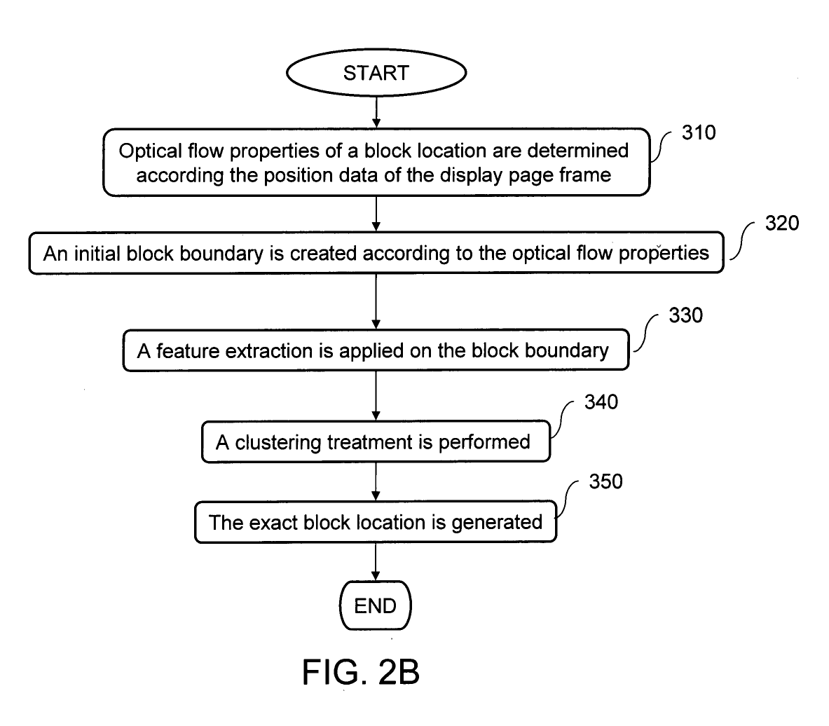

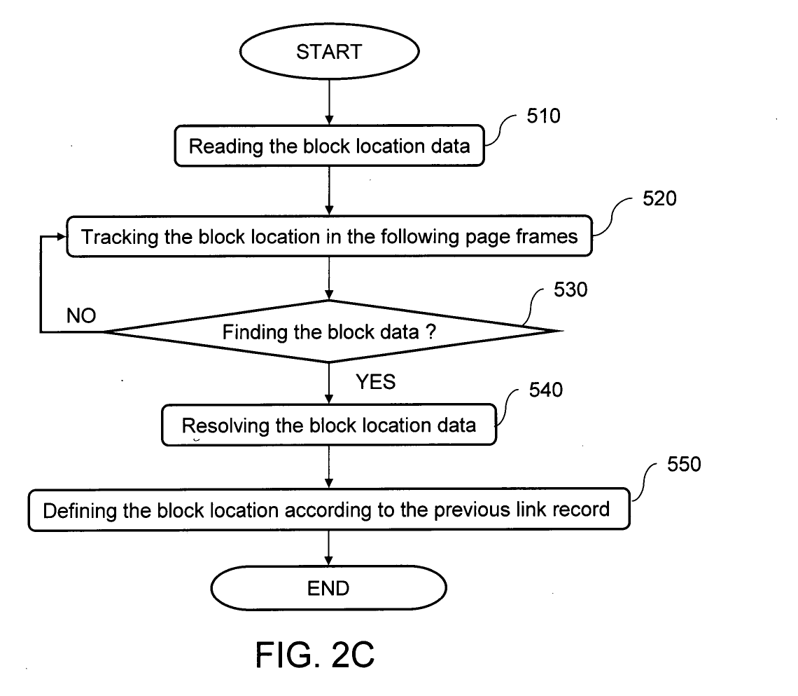

FIG. 2a is a flowchart of an interactive video data generating method according to an embodiment of the invention.

First, location data of the display page frame corresponding to a video data selection are analyzed (step 200). The location data are coordinate data, which are generated when the user triggers a sensitive display device or a pointing positioning device. According to the coordinate data, a block locating process is performed in the display page frames (step 300). This block locating process is detailed in FIG. 2b. After the block location has been determined, the user selects or inputs the video files or sections to be subjected to a link relation. The link records 830 of the display page frame, once being generated, are stored in the relation data document 820 (step 400). Subsequently, a tracking and defining process is performed on the next page frames of the video data selection (step 500), which is detailed in FIG. 2c. After the link definition has been achieved for the block locations found in the following page frames, the finally created relation data document 820 is saved up (step 600), which completes the interactive video data generating flow.

FIG. 2b is a flowchart of the block locating process according to an embodiment of the invention. First, optical flow properties of a block location are determined according the position data of the display page frame (step 310), i.e. the optical flow properties at the location selected by the user are determined. According to the optical flow properties, an initial block boundary is created (step 320), which is performed by using an optical flow analysis. A feature extraction then is applied on the initial block boundary (step 330), to eliminate contents without similar features. Lastly, a clustering treatment is performed (step 340), using adaptive bounding techniques to mark up remaining pixels with the same features, and thereby generate the exact block location (step 350).

It may happen that a same block location of a video data selection appears in different page frames. To avoid repeating the same block locating manipulation, a tracking and defining process (step 500) is performed on the following page frames of the video data selection to define a link record 830 for all the similar block locations in the same video data file. FIG. 2c details this tracking and defining process. First, block location information is read (step 510). This block location information includes block boundary data and link record 830 data. Spatio-temporal techniques then are implemented to track the same block location in the next page frame (step 520). According to the variations such as ‘in movement directions’, speed, locations, etc., the spatio-temporal techniques infer the position in the next page frame where the block location is likely to appear. Then it is determined whether the same block location is actually found therein (step 530). If no similar block location is found, tracking step 520 continues, otherwise the block location data are resolved (step 540) to determine the position data of the block location. The newly found block location is defined according to the link record 830 previously set by the user (step 550). The above steps 520 to 550 are repeated until the tracking and a defining process is achieved for the entire video data selection.

FIG. 3 is a schematic diagram illustrating the tracking and defining process implemented to generate the relation data document 830 according to an embodiment of the invention. In a display page frame (n) 801, two block locations 811 (HR1) and 812 (HR2) have been determined. Link record 830 of a corresponding relation data document 820 includes: a link file S1 of the block location 811 (HR1), and a link file F1 of the block location 812 (HR2). If the same block locations 811, 812 are tracked in a next page frame 802, the definition of the two block locations 811, 812 is automatically added to the corresponding relation data document 820. The page frame information in the link record 830, originally being n, will be consequently modified to [n, n+1] to indicate that the link record is suitable for the display page frame (n) 801 and the display page frame (n+1) 802. If the same block locations (HR1) 811 and (HR2) 812 are found again in the following page frame (n+2) 803, the definition of the block locations similarly is added to the corresponding relation data document 820, as illustrated. The page frame information in the link record 830 will be consequently modified to [n, n+2] to indicate that the link record is suitable for the display page frame (n) 801 through the display page frame (n+2) 803. Via this recurrent method, the user performs only one manipulation and all the same block locations of the video data selection are uniformly defined for broadcasting.

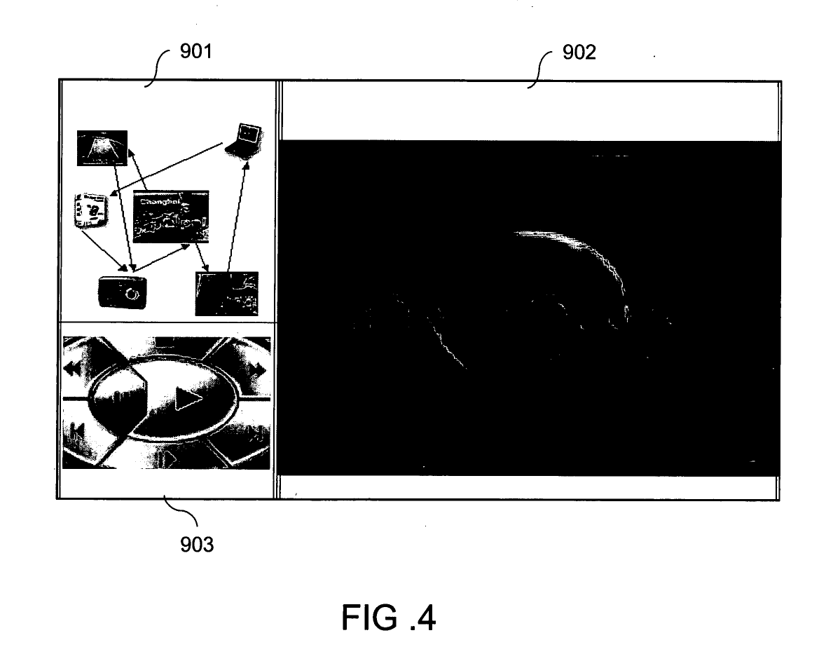

Video broadcasting can be performed via an interactive video-broadcasting interface. As illustrated in FIG. 4, an interactive video-broadcasting interface according to an embodiment of the invention includes a video data relation display area 901, a video-broadcasting area 902, and a user's manipulating area 903. The video data relation display area 901 can use a multiplicity of levels to show video data relations, so that the user immediately can visually appreciate the entire link relation structure between the video data. The video-broadcasting area 902 broadcasts the video file selected by the user, and the user's manipulating area 903 receives the user's selection/input as well as other diverse manipulation items for the video file.

It will be apparent to the person skilled in the art that the invention as described above may be varied in many ways, and notwithstanding remaining within the spirit and scope of the invention as defined in the following claims.

1. An interactive video data generating system, operable to perform link relation on a video data selected by the user so as to enable interactive broadcasting, the system comprising:
a file document database, storing video data files used as link relation and corresponding relation data documents;
a selection input module, generating an event-triggering signal according to a selection input manipulation from the user to perform selection input manipulation on video data files and display page frames of a video data selection;
a link display module, providing the user with an interface for displaying tables of the video data files, wherein the link display module receives the event-triggering signal to prompt a video data selection item and broadcasts the display page frames and the corresponding relation data documents;
a block defining module, performing a block locating process according to a user's selection input on a display page frame of a video data selection, and creating a link record in a corresponding relation data document of the video data selection; and
a relation generating module, wherein the relation generating module according to a block location information performs a tracking and defining process of similar block locations in following page frames of the video data selection, and adding definition results in corresponding relation data documents.

2. The system of claim 1, wherein the event-triggering signal is created at least by means of a sensitive display device or a pointing positioning device.

3. The system of claim 1, wherein the link display module uses a hierarchal menu to display the tables of the video data files and the link records of the relation data documents.

4. The system of claim 1, further comprising an interactive video-broadcasting interface, wherein the interactive video-broadcasting interface at lest comprises a user manipulating area, a video data relation displaying area, and a video-broadcasting area.

5. An interactive video data generating method, implemented to perform link relation on a video data selected by the user so as to enable interactive broadcasting, the method comprising:
analyzing a position information of display page frame from a selected video data;
performing a block locating process in the display page frame;
creating a link record of the display page frame, and saving it;
performing a tracking and defining process on following page frames of the video data selection; and
creating a relation data document of the video data selection.

6. The method of claim 5, wherein the position information includes coordinate data obtained from an event-triggering signal created by the manipulation of a sensitive display device or a pointing positioning device.

7. The method of claim 5, wherein performing a block locating process in the display page frame further comprises:
determining optical flow properties of a block location according to the position information of the display page frame;
generating a block boundary according to the optical flow properties;
performing a block feature extraction; and
performing a clustering process, and creating the block location.

8. The method of claim 5, wherein a link record at least includes page frame data, block data, a link data item, as well as a plurality of corresponding modules of the block data and the link data; wherein the page frame data is either a page frame number or a page frame range, and the link data is either a file or a section.

9. The method of claim 5, wherein performing a tracking and defining process on following page frames of the video data selection further comprising:
reading the block location data;
tracking the block location in the following page frames;
finding the block data and resolving the block location data; and
defining the block location according to the previous link record.

10. The method of claim 5, further comprising an interactive video-broadcasting interface having at least a user manipulating area, a video data relation displaying area, and a video-broadcasting area.
